(19) United States
(12) Patent Application Publication
(10) Pub. No.: US 2015/0154710 A1
(43) Pub. Date: Jun. 4, 2015

(54) SYSTEM AND METHOD FOR CALCULATING A PREMIUM FOR A LIFE INSURANCE OPTION

(71) Applicant: INSAMCO HOLDINGS, LLC, Santa Barbara, CA (US)

(72) Inventors: Jonathan H. SAMUELS, Santa Barbara, CA (US); William Joseph Schnaer, Greenwich, CT (US)

(73) Assignee: INSAMCO HOLDINGS, LLC, Santa Barbara, CA (US)

(21) Appl. No.: 14/095,225

(22) Filed: Dec. 3, 2013

(51) Int. Cl. G06Q 40/08

(52) U.S. Cl. CPC G06Q 40/08

(57) ABSTRACT

A method for identifying a premium for a guarantee of future insurability includes: receiving a premium guarantee request, the request including an age, deferral period, and risk class; identifying a selected class based on the risk class; receiving a plurality of lapse rates, base mortality rates, and subclass mortality rates, each based on the received age and identified selected class and associated with a policy year and/or subclass; identifying an assumed lapse proportion; calculating a zero-lapsed selected mortality rate based on the received lapse rates, base mortality rates, and subclass mortality rates; calculating a premium based on the calculated zero-lapse mortality rate using a calculation pricing model, the premium corresponding to a guarantee for future insurability of a policy holder at the age after the deferral period at the selected class; and transmitting the calculated premium in response to the premium guarantee request.

### FIELD

The present disclosure relates to the calculating of a premium risk for a life insurance option, specifically using a zero-lapse adjustment method to calculating a zero-lapse adjusted mortality rate and premium based thereon for a guarantee of future insurability based on a current risk class of an individual.

### BACKGROUND

Life insurance is commonly offered to customers as a way to insure the life of an individual against the financial consequences resulting from an untimely death. Generally, a life insurance policy pays a benefit if the insured life dies during the term of the policy, provided that the terms and the conditions of the policy have been fulfilled. For example, most life insurance policies require the continued payment of premiums in order to keep the policy active and not have the policy lapse.

Typically, life insurance policies that are offered to individuals are based on risk characteristics of each individual. In many instances, life insurance providers may group together individuals with similar risk characteristics into risk classes. Each of the risk classes may correspond to the probability of an individual in that risk class dying in each future period, sometimes referred to as the mortality risk expected to be experienced by an individual in that risk class. Mortality risk, sometimes referenced by a set of mortality rates, may be based on a number of factors, such as age and gender. The mortality risk, and thus the risk class to which an individual belongs, may affect the availability of a life insurance policy, the size of the policy available, the policy term, and the premium amount that the individual must pay for the policy.

In many instances, life insurance policies are available to individuals may specify a maximum term. Policies with term limits are often less expensive than policies that provide coverage for the remainder of an individual's life. While most term life insurance policies allow continuation after the term, continuation at premium rates is generally only attractive to terminally ill individuals. While an individual may obtain lifetime coverage by purchasing a sequence of term life policies, the risk characteristics of an individual can be reevaluated before each new policy is issued and a higher premium may be charged, due to the difference in age and possible change in medical or physical condition of the individual over the passage of time. Therefore, an individual may purchase a life insurance policy at a beneficial, low rate for five year term, but then be forced to purchase a new life insurance policy after the term at a significantly higher rate due not only to increase in age, but possible due to to placement in a different, less advantageous, risk class. This may result in individuals receiving less coverage, allowing their life insurance to lapse, or being unable to afford ongoing coverage entirely, which has a negative effect on both the individual and the policy provider.

Accordingly, such individuals would benefit from the use of an option to purchase future life insurance coverage at a present time, which would result in the individual being able to obtain a life insurance policy upon expiration of the option at premium rates which are based on a present risk class. However, current methods for calculating insurance premiums are based on mortality rates that are based on statistics gleaned from experience with ordinary life insurance policies, and thus are not suitable for the use in calculating a premium for a future guarantee of insurance. Thus, there is a need for a technical solution to calculate premiums for a guarantee of future insurability based on a present risk class.

### SUMMARY

The present disclosure provides a description of systems and methods for the calculating of a premium for a guarantee of future insurability based on a future risk class.

A method for identifying a premium for a guarantee of future insurability based on a future risk class includes: receiving, by a receiving device, an insurability guarantee request, wherein the insurability guarantee request includes at least a starting age, an exercise date at which insurance coverage may be purchased, and a particular risk class of a plurality of risk classes; receiving, by the receiving device, mortality rate data including a plurality of base mortality rates based on an experience, wherein each base mortality rate is associated with the selected risk class, an age, and a policy year and corresponds to a rate of mortality of policy holders of an insurance policy corresponding to the associated risk class, age, and policy year; receiving, by the receiving device, lapse rate data including a plurality of lapse rates based on the experience or a comparable experience, wherein each lapse rate is associated with the selected risk class, an age, and a policy year, and corresponds to a rate at which policy holders of an insurance policy let their policy lapse as of the end of the associated policy year; storing, in a mortality database, the received mortality rate data; storing, in a lapse database, the received lapse rate data; identifying, by the processing device, an assumed lapse proportion, wherein the assumed lapse proportion represents a proportion of policy holders of an insurance policy that let their policy lapse who experience a lower mortality rate than policy holders of an insurance policy that do not let their policy lapse; calculating, by the processing device, a plurality of subclass mortality rates, wherein each subclass mortality rate is associated with a selected risk class, an age, a policy year, and a subclass, and corresponds to a rate of mortality of policy holders of an insurance policy corresponding to the associated risk class, age, policy year, and subclass; calculating, by the processing device, a zero-lapsed selected mortality rate, wherein calculating the zero-lapsed selected mortality rate comprises (i) calculating, for each deferral year up to the exercise date, an original class issue based on a total population value and subclass population values, the total population value being based on a previous total population value and a base mortality rate, and the subclass population values being based on (a) a previous original class issue, lapse rate, and assumed lapse proportion if an associated subclass is equivalent to the deferral year, and (b) a previously subclass population value and a subclass mortality rate if an associated subclass is not equivalent to the deferral year, (ii) calculating, for the exercise date, a number of expected deaths based on the original class issue, base mortality rate, subclass population values, and subclass mortality rates for the last deferral year up to the exercise date, and (iii) calculating the zero-lapsed mortality rate based on the number of expected deaths and the total population value for the last deferral year up to the exercise date; calculating, by the processing device, a premium based on the calculated zero-lapse mortality rate using a calculation pricing model, wherein the premium corresponds to a guarantee of insurability of a policy holder at the starting age after the exercise date at the selected risk class; and transmitting, by a transmitting device, the calculated premium in response to the insurability guarantee request.

A system for identifying a premium for a guarantee of future insurability includes, a mortality database, a lapse database, a transmitting device, a receiving device, and a processing device. The receiving device is configured to receive: an insurability guarantee request, wherein the insurability guarantee request includes at least a starting age, an exercise date at which insurance coverage may be purchased, and a particular risk class of a plurality of risk classes; mortality rate data including a plurality of base mortality rates based on experience, wherein each base mortality rate is associated with the selected risk class, an age, and a policy year and corresponds to a rate of mortality of policy holders of an insurance policy corresponding to the associated risk class, age, and policy year; and lapse rate data including a plurality of lapse rates based on the experience or a comparable experience, wherein each lapse rate is associated with the selected risk class, an age, and a policy year, and corresponds to a rate at which policy holders of an insurance policy let their policy lapse as of the end of the associated policy year. The processing device is configured to: store, in the mortality database, the received mortality rate data; store, in the lapse database, the received lapse rate data; identify an assumed lapse proportion, wherein the assumed lapse proportion represents a proportion of policy holders of an insurance policy that let their policy lapse who experience a lower mortality rate than policy holders of an insurance policy that do not let their policy lapse; calculate a plurality of subclass mortality rates, wherein each subclass mortality rate is associated with a selected risk class, an age, a policy year, and a subclass, and corresponds to a rate of mortality of policy holders of an insurance policy corresponding to the associated risk class, age, policy year, and subclass; calculate a zero-lapsed selected mortality rate, wherein calculating the zero-lapsed selected mortality rate comprises (i) calculating, for each deferral year to the exercise date, an original class issue based on a total population value and subclass population values, the total population value being based on a previous total population value and a base mortality rate, and the subclass population values being based on (a) a previous original class issue, lapse rate, and assumed lapse proportion if an associated subclass is equivalent to the deferral year, and (b) a previously subclass population value and a subclass mortality rate if an associated subclass is not equivalent to the deferral year, (ii) calculating, for the deferral year, a number of expected deaths based on the original class issue, base mortality rate, subclass population values, and subclass mortality rates for the last deferral year up to the exercise date, and (iii) calculating the zero-lapsed mortality rate based on the number of expected deaths and the total population value for the last deferral year up to the exercise date; and calculate a premium based on the calculated zero-lapse mortality rate using a calculation pricing model, wherein the premium corresponds to a guarantee of insurability of an insured at the starting age at the exercise date at the selected risk class. The transmitting device is configured to transmit the calculated premium in response to the insurability request.

A non-transitory computer readable recording medium for having a program stored therein that causes a processor of a computing device to execute a method for identifying a premium for a guarantee of future insurability based on a future risk class includes the following steps: receiving, by a receiving device, an insurability guarantee request, wherein the insurability guarantee request includes at least a starting age, an exercise date at which insurance coverage may be purchased, and a particular risk class of a plurality of risk classes; receiving, by the receiving device, mortality rate data including a plurality of base mortality rates based on an experience, wherein each base mortality rate is associated with the selected risk class, an age, and a policy year and corresponds to a rate of mortality of policy holders of an insurance policy corresponding to the associated risk class, age, and policy year; receiving, by the receiving device, lapse rate data including a plurality of lapse rates based on the experience or a comparable experience, wherein each lapse rate is associated with the selected risk class, an age, and a policy year, and corresponds to a rate at which policy holders of an insurance policy let their policy lapse as of the end of the associated policy year; storing, in a mortality database, the received mortality rate data; storing, in a lapse database, the received lapse rate data; identifying, by the processing device, an assumed lapse proportion, wherein the assumed lapse proportion represents a proportion of policy holders of an insurance policy that let their policy lapse who experience a lower mortality rate than policy holders of an insurance policy that do not let their policy lapse; calculating, by the processing device, a plurality of subclass mortality rates, wherein each subclass mortality rate is associated with a selected risk class, an age, a policy year, and a subclass, and corresponds to a rate of mortality of policy holders of an insurance policy corresponding to the associated risk class, age, policy year, and subclass; calculating, by the processing device, a zero-lapsed selected mortality rate, wherein calculating the zero-lapsed selected mortality rate comprises (i) calculating, for each deferral year up to the exercise date, an original class issue based on a total population value and subclass population values, the total population value being based on a previous total population value and a base mortality rate, and the subclass population values being based on (a) a previous original class issue, lapse rate, and assumed lapse proportion if an associated subclass is equivalent to the deferral year, and (b) a previously subclass population value and a subclass mortality rate if an associated subclass is not equivalent to the deferral year, (ii) calculating, for the exercise date, a number of expected deaths based on the original class issue, base mortality rate, subclass population values, and subclass mortality rates for the last deferral year up to the exercise date, and (iii) calculating the zero-lapsed mortality rate based on the number of expected deaths and the total population value for the last deferral year up to the exercise date; calculating, by the processing device, a premium based on the calculated zero-lapse mortality rate using a calculation pricing model, wherein the premium corresponds to a guarantee of insurability of a policy holder at the starting age after the exercise date at the selected risk class; and transmitting, by a transmitting device, the calculated premium in response to the insurability guarantee request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a processing server for calculating a zero-lapse adjusted mortality rate and premium based thereon for a guarantee of future insurability in accordance with exemplary embodiments.

FIG. 2 is a high level diagram illustrating a system for requesting and providing a premium for a guarantee of future insurability including the processing server of FIG. 1 in accordance with exemplary embodiments.

FIG. 3 is a flow diagram illustrating a method for fulfilling a request for a premium for a guarantee of future insurability in accordance with exemplary embodiments.

FIG. 4 is a flow chart illustrating a method for calculating a premium using a zero-lapse adjusted method in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Processing Server

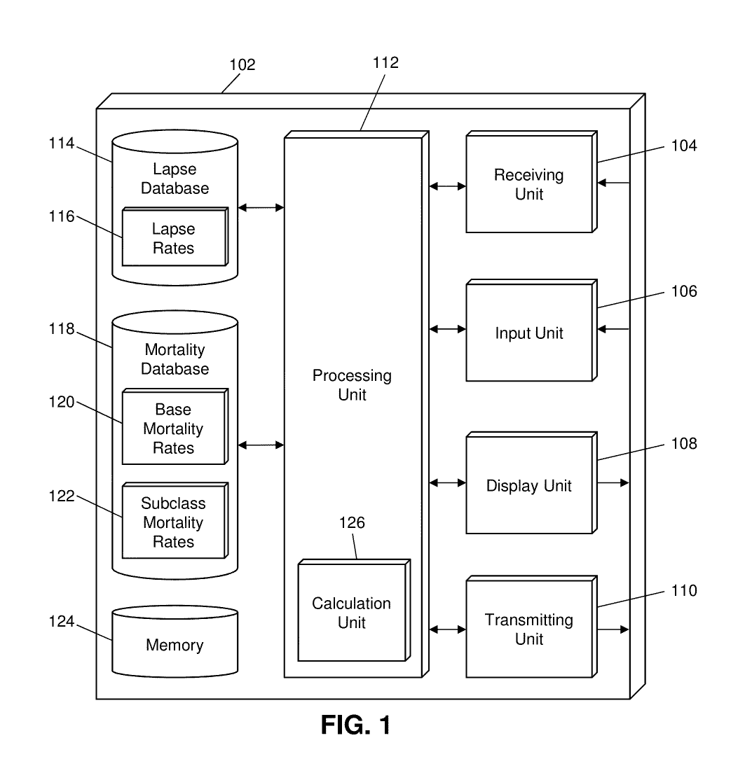

FIG. 1 illustrates a processing server 102 configured to use a zero-lapse adjusted method to calculate a premium for a guarantee of future insurability. It will be apparent to persons having skill in the relevant art that the embodiment of the processing server 102 illustrated in FIG. 1 is provided as illustration only and may not be exhaustive to all possible configurations of the processing server 102 suitable for performing the functions as discussed herein. It will be further apparent to persons having skill in the relevant art that the “guarantee of future insurability” may refer to a “life insurance option” or a policy that may be available to a policy holder in the future (e.g., after a deferral period) for a guaranteed premium.

The processing server 102 may include a receiving unit 104. The receiving unit 104 may be any type of unit configured to receive data from one or more sources via methods or protocols that will be apparent to persons having skill in the relevant art. For example, the receiving unit 104 may be configured to receive data from the Internet via a wired or wireless local area network (LAN). The receiving unit 104 may receive a premium guarantee request, which may be a request for a premium for a future guarantee of insurability. The premium guarantee request may include at least a starting age of the insured, a deferral period, and a risk class. The starting age may be the age of the insured at the time of the receipt of the request. The deferral period may be a period of time after which a life insurance policy to which a guarantee of future insurability applies becomes effective. For example, a five year deferral period may indicate that the request is for a premium of an insurance policy that will become effective five years after purchase of the option.

The risk class may be a risk class of a plurality of risk classes associated with the individual for which the premium is requested. In some embodiments, the request may include a plurality of risk characteristics, and the risk class associated with the individual may be identified based on one or more of the risk characteristics. Such an identification may be made by a processing unit 112 included in the processing server 102. Systems and methods used to identify a risk class based on one or more risk characteristics will be apparent to persons having skill in the relevant art.

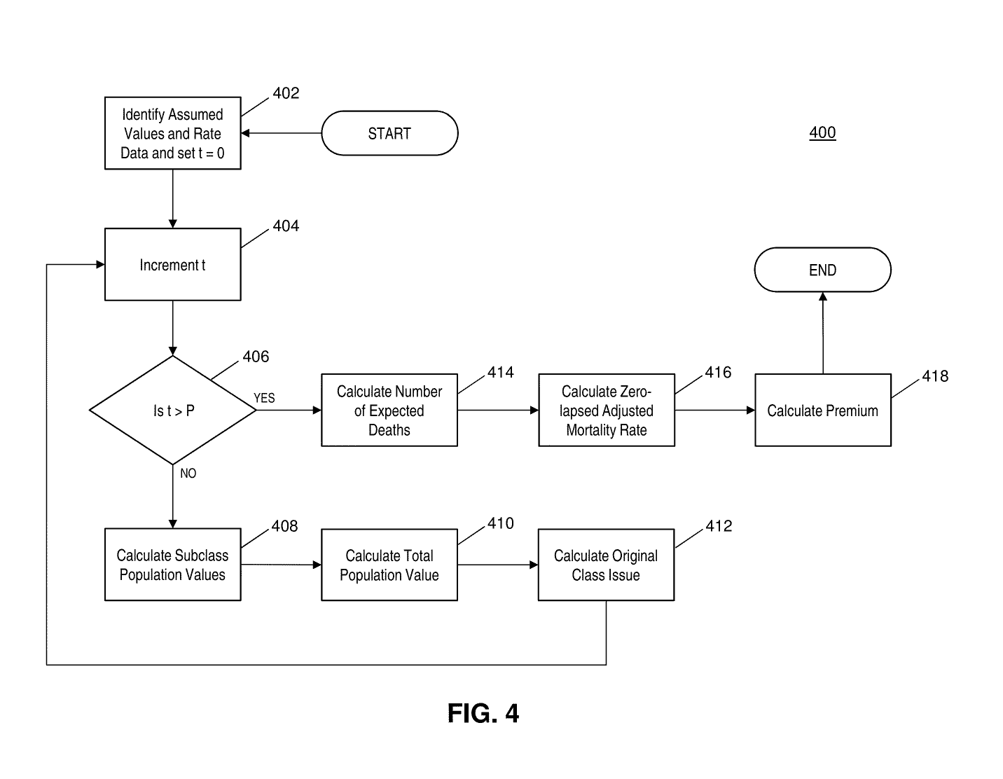

The processing unit 112 may be further configured to calculate a premium in response to the premium guarantee request. In an exemplary embodiment, the processing unit 112 may use a zero-lapse adjusted method, discussed in more detail below with respect to FIG. 4, to calculate the premium. The calculations may be performed by a calculation unit 126, which may be part of the processing unit 112 or external to the processing unit 112 and/or the processing server 102.

The processing unit 112 may be configured to utilize data stored in one or more databases in order to perform the zero-lapse adjusted method. The data may include at least lapse rates 116, base mortality rates 120, and subclass mortality rates 122. The lapse rates 116 may be stored in a lapse database 114. Lapse rates may be rates that are associated with at least an age, policy year, and risk class that correspond to a rate at which policy holders of an insurance policy let their policy lapse as of the end of the associated policy year. For example, there may be a lapse rate corresponding to the fourth policy year for policies entered into by 50-year-olds, which may correspond to the rate that the policy holders, who were 50 at the time of entering their policy, may let their policy lapse by the end of their fourth year of the policy. Lapse rates may be further associated with additional criteria as will be apparent to persons having skill in the relevant art, such as tobacco usage, drug usage, gender, medical condition, etc.

The base mortality rates 120 and the subclass mortality rates 122 may be stored in a mortality database 118. The base mortality rates 120 may be associated with an age, policy year, and risk class, and correspond to the rate of mortality of policy holders of an insurance policy as applicable to the associated information. For example, a mortality rate corresponding the fourth policy year for policies entered into by 50-year-olds may correspond to the rate of mortality for policy holders who were 50 at the time of entering their policy as of the end of their fourth year of the policy. Subclass mortality rates 122 may be similar to base mortality rates 120, but may be further associated with a subclass. A subclass may be represented as an age or policy year and may represent policy holders at the particular age or policy year who let their policy lapse as of the end of that policy year. Accordingly, there may be at least one subclass for every completed year of an insurance policy. For example, in after the first year of an insurance policy with a five year term to 50-year-olds, there may be subclass corresponding to all of those policy holders who let their policy lapse at the end of the first year, and may be referred to as the age 51 (e.g., age of the policy holders at the end of the first year) subclass. At the end of the second year, there may be an additional subclass corresponding to policy holders who, after continuing their policy after the first year, let their policy lapse as of the end of the second year. Subclasses are discussed in more detail below with respect to the zero-lapse adjusted method discussed in relation to FIG. 4.

The base mortality rates 120 and subclass mortality rates 122 may be based on sources of mortality rates that will be apparent to persons having skill in the relevant art. In some instances, the mortality rates may be based on mortality rates published in a valuation basic mortality table. In other instances, the mortality rates may be based on rates calculated using a zero-lapse adjusted method, discussed in detail below. In one embodiment, the mortality rates may be calculated based on experience. In some cases, mortality rate data may be received by the receiving unit 104, such as from an external source (e.g., a provider of valuation basic mortality tables). In another embodiment, the mortality rates may be calculated and/or identified by the processing unit 112.

The processing server 102 may also include a memory 124. The memory 124 may be configured to store additional data, such as identified values used in the execution of the zero-lapse adjusted method, discussed in more detail below. The memory 124 may also store program code for application programs, and other additional information that will be apparent to persons having skill in the relevant art. For example, the memory 124 may store program code for an application program to be executed by the processing unit 112 for the input of information and display of a calculated premium, such as to be used by an insurance agent. To this end, the processing server 102 may further include an input unit 106 and a display unit 108.

The input unit 106 may be any type of input unit or device configured to receive input from a user. For example, the input unit 106 may be a keyboard, mouse, touch screen, click wheel, microphone, camera, etc. In one embodiment, the input unit 106 may be configured to receive data corresponding to a premium guarantee request as input by a user, such as the input of premium request data by an insurance agent. It will be apparent to persons having skill in the relevant art that data received by the input unit 106 may then be transmitted to and received by the receiving unit 104, which may be utilized to interface the input unit 106 with the processing unit 112. Additional configurations of the input unit 106 and the receiving unit 104 as part of the processing server 102 will be apparent to persons having skill in the relevant art.

The display unit 108 may be any type of display configured to display data or other information to a user, such as a touch screen, a liquid crystal display, a light-emitting diode display, a light projection display, etc. The display unit 108 may be configured to display a premium to a user, such as a premium calculated in response to a received premium guarantee request. In some instances, the display unit 108 may be interfaced with the processing unit 112 via a transmitting unit 110. The transmitting unit 110 may be configured to receive data (e.g., a premium calculation) from the processing unit 112 may transmit the data to the display unit 108 for display. Additional configurations of the display unit 108 and the transmitting unit 110 as part of the processing server 102 will be apparent to persons having skill in the relevant art.

The transmitting unit 110 may be also configured to transmit the premium data, and/or any other information (e.g., risk rates, risk classes, etc.). The transmitting unit 110 may be configured to transmit data via one or more networks or protocols, such as using the Internet via a LAN.

### System Architecture

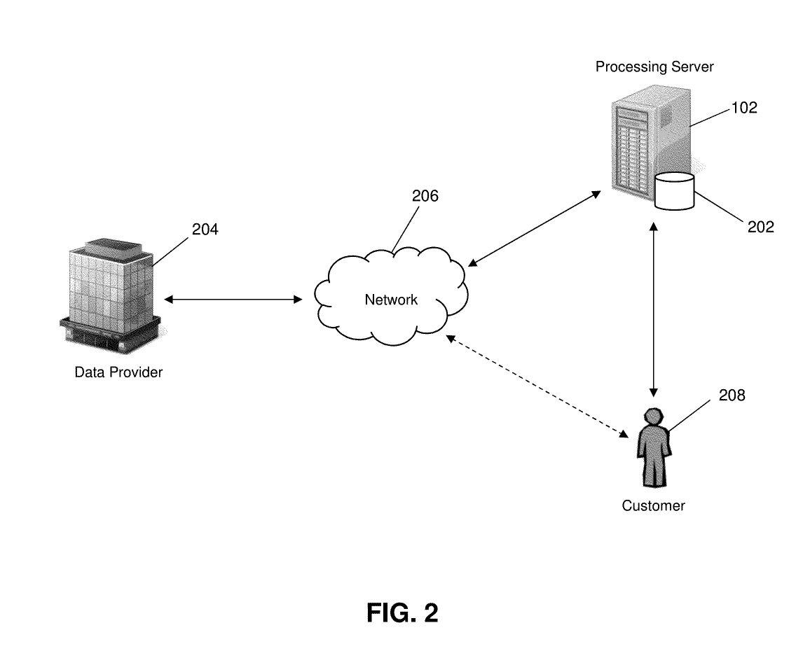

FIG. 2 illustrates a high-level architecture of a system 200 including the processing server 102 for the calculation of a premium for a guarantee of future insurability. The system 200 may include the processing server 102, which may include the databases 202, such as the lapse database 114, the mortality database 118, and the memory 124.

The system 200 may also include a data provider 204. The data provider 204 may be configured to provide data for use in the calculation of premiums to the processing server 102, such as lapse rate data and mortality rate data. In some embodiments, the data provider 204 may be configured to transmit the data via a network 206 to the processing server 102 (e.g., to be received by the receiving unit 104). The network 206 may be any network suitable for performing the functions as disclosed herein, such as a local area network, wide area network, wireless network, wired network, radio frequency, the Internet, coaxial cable, etc. The processing server 102 may receive the data from the data provider 204 via the network 206 and may store the data in the corresponding databases 202. For example, the data provider 204 may be the Society of Actuaries, and may provide the valuation basic table of mortality rates to the processing server 102.

The system 200 may also include a customer 208. The customer 208 may submit a request for a premium for a guarantee of future insurability to the processing server 102. Methods for the submission of a request to the processing server 102 will be apparent to persons having skill in the relevant art and may include submission via a computing device, direct input (e.g., via the input unit 106), submission via another user (e.g., providing the data to an insurance agent, who may then input the information directly or via a computing device), etc. In some instances, the customer 208 may submit the request and/or data to be included in the request via the network 206. For example, the customer 208 may submit a request for a premium over the Internet via a webpage.

The processing server 102 may then receive the request and calculate the premium using the zero-lapse adjusted method, discussed in detail below. The processing server 102 may then transmit (e.g., via the transmitting unit 110) the calculated premium to the customer 208.

### Method for Fulfillment of a Request for a Premium

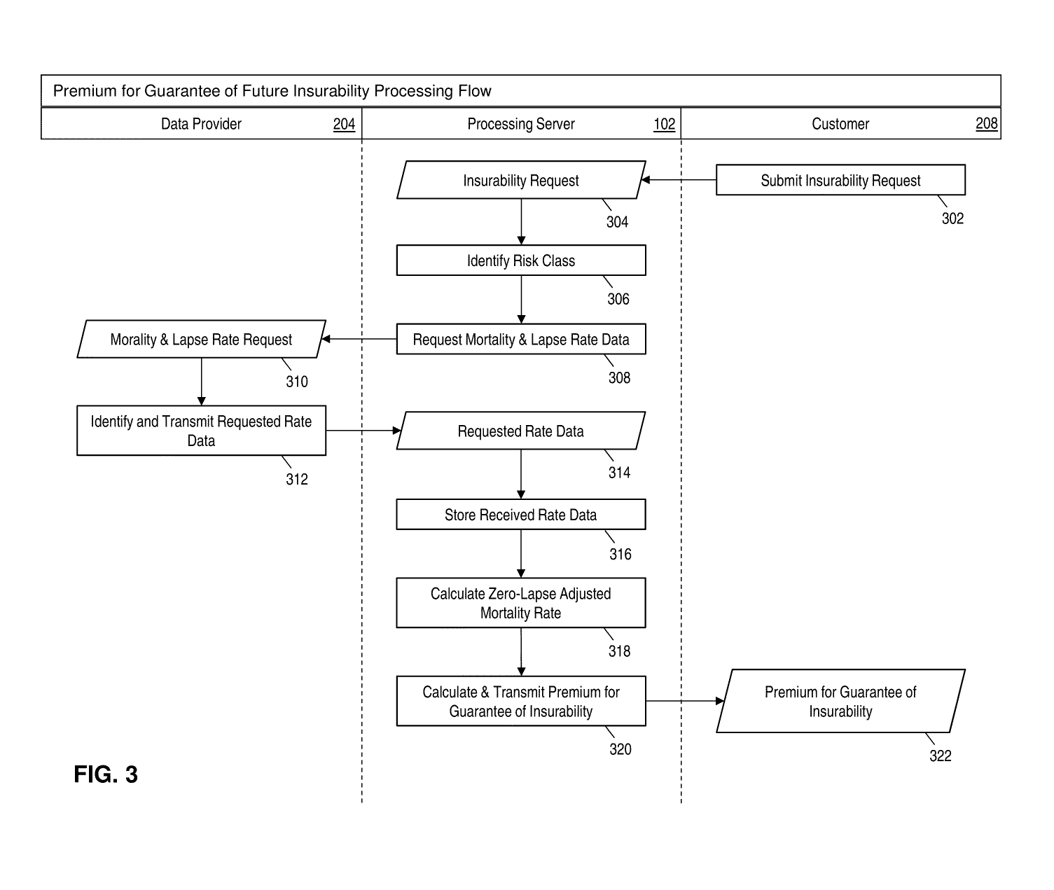

FIG. 3 illustrates a method for the fulfillment of a request for a premium using the system 200 of FIG. 2 and the processing server 102 of FIG. 1. In step 302, the customer 208 may submit an insurability guarantee request to the processing server 102, who may receive the insurability guarantee request in step 304. In an exemplary embodiment, the insurability guarantee request may include at least a starting age, an exercise date at which insurance coverage may be purchased, and a particular risk class of a plurality of risk classes. The particular risk class may be based on at least a gender, smoking status, and underwriting class of the customer 208. In some instances, the insurability guarantee request may include the gender, smoking status, and underwriting class, and the processing server 102 may identify the particular risk class based thereon.

In step 306, the processing server 102 (e.g., the processing unit 112) may identify a selected risk class. In an exemplary embodiment, the selected risk class may be one of the particular risk class included in the request, or a risk class associated with the risk class. In embodiments where the selected risk class may not be the particular risk class, the risk class may be selected based on an estimation of the risk characteristics of the customer 208 at the time that the policy would take effect (e.g., after the exercise date). For example, a 50 year old submitting the request to obtain a guarantee of future insurability may be in one risk class, while a 55 year old with the same other characteristics may be in a second risk class. As such, if the 50 year old were to submit a request for a premium for an insurance policy to be effective after a five year deferral period, the processing server 102 may identify the second risk class to be used to calculate the premium. It should be apparent to persons having skill in the relevant art that step 306 may be an optional step.

In step 308, the processing server 102 may request lapse and mortality rate data from the data provider 204. In one embodiment, the data provider 204 may be part of the processing server 102, such as the databases 202. In step 310, the data provider 204 may receive the lapse and mortality rate request, which may include at least the starting age and exercise date included in the premium request, and the selected risk class. In step 312, the data provider 204 may identify the requested rate data, which may include lapse rates 116 and base mortality rates 120 for each policy year of the deferral period starting from the starting age to the exercise date, and subclass mortality rates 122 for each subclass of each policy year of the deferral period from the starting age to the exercise date.

In step 314, the processing server 102 may receive the requested rate data, which may then be stored in the databases 202 in step 316. It will be apparent to persons having skill in the relevant art that step 316 may be optional. In step 318, the processing server 102 may calculate a zero-lapsed adjusted mortality rate for the end of the deferral period (e.g., at the exercise date) based on the starting age included in the premium request, using the requested rate data. A method for calculating the zero-lapsed adjusted mortality rate is discussed in more detail below with respect to FIG. 4.

In step 320, the processing server 102 may calculate a premium based on the calculated zero-lapsed adjusted mortality rate, and then transmit (e.g., via the transmitting unit 110) the calculated premium to the customer 208. In some embodiments, the processing server 102 may first calculate a risk rate based on the zero-lapsed adjusted mortality rate, and then calculate the premium based on the risk rate. The risk rate may be further based on interest, persistency, and expenses and may be related to the present value of the excess mortality expected to be experienced by a target policy from its date of issue as a result of the exercise of the guarantee of insurability over the mortality that would have been experienced by a similar, newly underwritten policy issued on the exercise date in the same risk class as the target policy. The premium calculated based on the risk rate may be transformation of the risk rate using a calculation pricing model.

The calculated premium may also be based on one or more pricing assumptions, in addition to the calculated zero-lapsed adjusted mortality rate. The pricing assumptions will be apparent to persons having skill in the relevant art and may include an investment earnings rate, federal income tax (e.g., percentage of statutory reserves deemed deductible, FIT rate, etc.), and financial reinsurance (e.g., cost per dollar of surplus relief, retention, etc.).

In step 322, the customer 208 may receive the premium for guarantee of insurability. In some embodiments, the premium may be a single premium. In other embodiments, the premium may be a periodic premium. In a further embodiment, the periodic premium may be paid throughout the deferral period (e.g., up to the exercise date). In an alternative further embodiment, the periodic premium may be made through both the deferral and benefit periods. It will be apparent to persons having skill in the relevant art that, in some embodiments, the premium may be based on additional criteria that may be provided in the premium guarantee request. For example, additional criteria may include gender, medical condition, alcohol usage, tobacco usage, drug usage, medical history, family medical history, etc. In some instances, the lapse rates 116, the base mortality rates 120, and/or the subclass mortality rates 122 may be further associated with the additional criteria.

In some embodiments, the processing server 102 may be further configured to calculate a reserve. The reserve may be used by the processing server 102 in the calculation of the premium. In some instances, the reserve may be the discounting of the excess cost of the benefits guaranteed by the target policy to which the premium is associated over the costs of the same benefits for a similar policy issued on the exercise date (e.g., after the deferral period) of the target policy in the same underwriting class to a newly underwritten policy. Factors that may be included in the calculation of a reserve may include future expected expenses, lapse rates (e.g., the lapse rates 116), rates of disability, etc. Methods for calculating the reserve may include an asset adequacy method, a 1-table method, a 2-table method, and a reserve differential method.

The asset adequacy method may include calculating the reserve as the present value of all future cash flows. The processing server 102 may, under the asset adequacy method, calculate the present value anytime from the start of during the deferral period to the end of the benefit period. Methods for calculating the present value of future cash flows will be apparent to persons having skill in the relevant art. In some embodiments, the calculation of the present value may be based on rates and/or other assumptions utilized in the calculation of the premium itself.

The 1-table method may utilize two sets of mortality rates to calculate the reserve. The first set of mortality rates may be mortality rates based on the issue age of the life insurance option (e.g., the starting age received in the premium guarantee request). The second set of mortality rates may be based on the issue age of the target policy issued as a result of the exercise of the life insurance option by the customer 208, which may be the starting age plus the deferral period. The reserve may then be calculated based on the excess of the present value of future benefits during the benefit period using the first set of mortality rates over the present value calculated using the second set of mortality rates.

The 2-table method may calculate the reserve in the same manner as the 1-table method, but utilizing a first and second mortality table rather than first and second sets of mortality rates. The first and second morality tables may be any tables suitable for use in calculating the reserve as will be apparent to persons having skill in the relevant art, such as a Commissioner's Standard Ordinary (CSO) Preferred Class Structure Mortality Table and a Valuation Basic Table.

The reserve differential method may be performed in the same manner as the 2-table method, but with each of the mortality tables first multiplied by a factor prior to the calculation of the reserve. The first mortality table may be multiplied by a factor that is the ratio of the present value of future expected pricing or actual experience mortality divided by the present value of future mortality for the chosen table relative to a policy issued on the issue date of the life insurance option. The factor used to determine the second mortality table may be the ratio of the present value of future expected pricing or actual experience mortality divided by the present value of future mortality for the chosen table relative to a policy issued on the exercise date (e.g., at the end of the deferral period) of the life insurance option. In an exemplary embodiment, both factors may be greater than 0.2 or 20%.

In some embodiments, the processing server 102 may also obtain additional assumptions to be used in the calculation of the premium. For example, nonforfeiture values, such as a nonforfeiture interest rate and mortality table, may be assumed. In addition, the processing server 102 may obtain assumptions regarding risk-based capital, such as percentage of reserve and percentage of target policy face amount. This information may be used as part of the process for calculating the premium as will be apparent to persons having skill in the relevant art.

The premium for guarantee of future insurability and corresponding life insurance option may be structure in any suitable manner as will be apparent to persons having skill in the relevant art. In one embodiment, the life insurance option may be structured such that the customer 208 may pay the premium during the deferral period to continue the guarantee, and then on an exercise data at the end of the deferral period, exercise the life insurance option and pay premiums at a rate determined based on the selected risk class. In another embodiment, the life insurance option may be an option that may be purchased for the premium or a face amount, and then exchanged by the customer 208 for a corresponding life insurance policy after the deferral period. In yet another embodiment, the life insurance option may be designed as a rider attached to a life insurance policy with a term equal to the deferral period.

### Zero-Lapse Adjust Method for Calculating Mortality Rates

FIG. 4 illustrates a method 400 for the calculation of a zero-lapse adjusted mortality rate by the processing server 102 using a zero-lapsed adjust method.

The zero-lapse adjust method may be used to adjust for the anti-selective effect on mortality of lapses embedded in insurance data used to develop and construct traditional mortality tables. The adjusted zero-lapse mortality rate may therefore reflect the underlying mortality experience of individuals who lapse their insurance policies in addition to those individuals that continue their insurance policies. The zero-lapse adjust method may operate by calculating survivors as of the beginning of each policy year starting at a starting age to the exercise date, which may include both individuals with lapsed policies and those with ongoing policies.

Prior to executing the method 400, the processing server 102 may receive the premium guarantee request including at least a starting age, y, an exercise date at which insurance coverage may be purchased, P, and a risk class, and may identify a selected risk class, as discussed above with respect to the method illustrated in FIG. 3. In step 402, the processing unit 112 of the processing server 112 may identify rate data and assumed values based on the starting age, exercise date, and risk class. The processing unit 112 may also set a deferral year, t, to 0, which may correspond to the most recently completed policy year for use in calculating the zero-lapse mortality rate.

Identifying rate data may include identifying, in the lapse database 114, a plurality of lapse rates, wₜ, where each lapse rate is associated with the starting age y and corresponds to each deferral year t from the first deferral year, where t=1, to the exercise date, where t=P. Table 1 includes an illustration of example lapse rates identified corresponding to a premium guarantee request identifying a starting age of y=50 and an exercise date of P=5 years from the start of the deferral period.

TABLE 1
Lapse Rates by Deferral Year—Starting Age of 50.

| | Deferral Year (t) | | | | |
|---|---|---|---|---|---|
| | 1 | 2 | 3 | 4 | 5 |
| Lapse Rate (w) | 0.022 | 0.035 | 0.038 | 0.048 | 0.04 |

Identifying rate data in step 402 may further include identifying, in the mortality database 118, a plurality of base mortality rates, Mₜ, where each base mortality rate is associated with the starting age y and corresponds to each deferral year t when 1≦t≦P. The processing unit 112 may also identify, in the mortality database 118, a plurality of subclass mortality rates, m_{s,t}, where each subclass mortality rate is associated with the starting age y, and where s is the associated subclass and t is the deferral year. It will be apparent to persons having skill in the relevant art that s may be represented as an age, deferral year, or any other suitable measure of reference. Table 2 below illustrates base and subclass mortality rates identified by the processing server 102 in the example of a request for a premium for a guarantee of insurability with a starting age of y=50 and a deferral period of P=5 years.

TABLE 2
Mortality Rates by Subclass—Starting Age of 50.

| | Deferral Year (t) | | | | |
|---|---|---|---|---|---|
| | 1 | 2 | 3 | 4 | 5 |
| Age (y) 50 | 0.00051 | 0.00089 | 0.00120 | 0.00146 | 0.00170 |
| Subclass (s) 51 | 0.00057 | 0.00097 | 0.00129 | 0.00157 | 0.00180 |
| Subclass (s) 52 | | 0.00063 | 0.00106 | 0.00141 | 0.00170 |
| Subclass (s) 53 | | | 0.00071 | 0.00116 | 0.00154 |
| Subclass (s) 54 | | | | 0.00079 | 0.00127 |
| Subclass (s) 55 | | | | | 0.00087 |

In the example illustrated in Table 2, the base mortality rate during the third deferral year, M₃=0.00120, which represents the mortality rate of those individuals with ongoing policies as of the end of the third deferral year. The subclass mortality rate m_{52,3} represents the mortality rate as of the end of the third deferral year of those individuals who let their insurance coverage lapse as of the end of the second deferral year (e.g., when the age is 52).

In step 402, the processing unit 112 may also identify an assumed lapse proportion, L. The assumed lapse proportion L may represent a proportion of policy holders that let their policy lapse who experience a lower mortality rate than policy holders of an insurance policy that do not let their policy lapse. It will be apparent to persons having skill in the relevant art that the proportion L may be identified based on a variety of factors depending on the application and may vary accordingly. In the example discussed herein, the processing unit 112 may identify an assumed lapse proportion of L=0.7, which may represent that 70% of individuals that let their policy lapse have a lower mortality rate than the individuals that retain their policy. The processing unit 112 may also identify the deferral year, t, as being equal to 0 to begin the calculation of the zero-lapse adjusted mortality rate.

In step 404, the processing unit 112 may increment t. Then, in step 406, the processing unit 112 may identify if t>P, such that the calculations will be performed for each year up to the exercise date. If the deferral year has not yet exceeded the deferral period, then, in step 408, the calculation unit 126 of the processing unit 112 may calculate subclass population values, S_{s,t}, where s is the subclass and t is the deferral year. The subclass population values may be calculated using the following formulas:

S_{s,t}=Oₜ₋₁*wₜ*L when s=(y+t) (1)

S_{s,t}=(S_{s,t-1}*m_{s,t}) when y<s<+t) (2)

Equation 1 may be used to calculate the subclass population value when the subclass, represented as an age, is equal to y+t, and equation 2 may be used to calculate the subclass population value when the subclass is greater than the starting age y and less than y+t. Accordingly, for each deferral year t, the calculation unit 126 may calculate t subclass values.

The variable O used in equation 1 may be an original class issue, Oₜ, wherein the original class issue represents the number of policy holders who have continued to retain their policy as of the end of the policy year. The original class issue may be calculated by using the following formula:

Oₜ=Iₜ−(S_{y+t,t}−S_{y+t-1,t}− . . . −S_{y+1,t}) when t>0 (3)

The value for O₀, which is used in the calculation of the first subclass population value during the first execution of step 408 in the method 400, may be a predetermined number. In some embodiments, such as the example discussed herein, the predetermined number may be 1,000, which may represent 1,000 policy holders holding a life insurance policy as of the exercise date P.

In equation 3, the value Iₜ may be a total population value for the deferral year t, which may represent the number of total survivors, including both policy holders who have let their policies lapse and those that have retained them, as of the end of the deferral year t. It will be apparent to persons having skill in the relevant art that the total population value at the start of the deferral period, I₀ may be the same value as O₀. The population value may be calculated using the following formula:

Iₜ=Iₜ₋₁−(Iₜ₋₁*Mₜ) (4)

Once the subclass population value(s) have been calculated, then, in step 410, the calculation unit 126 may calculate the total population value for the deferral year using equation 4. Then, in step 412, the calculation unit 126 may calculate the original class issue for the deferral year using equation 3 and the total population value and subclass population value(s) calculated in the preceding steps.

Following the calculation of the original class issue, the method 400 may return to step 404, where the processing unit 112 may increment t to the next deferral year. Then, the processing unit 112 may again identify if t>P. If calculations for the deferral period has not yet been completed, when t is less than P, then the calculation unit 126 may calculate the subclass population values, total population value, and original class issue again for the new deferral year. If, on the other hand, the calculations for the deferral period have been completed, then the method 400 may proceed to step 414.

In step 414, the calculation unit 126 may calculate the number of expected deaths, D, of individuals who originally held policies at the start of the deferral period as of the exercise date. The number of expected deaths may be calculated based on the original class issue as of the exercise date, the subclass population values, and the corresponding mortality rates as identified during step 402, using the following formula:

D=(oₚ*Mₚ)+[(S_{y+p,p}*m_{y+p,p})+(S_{y+p-1,p}*m_{y+p-1,p})+ . . . +(S_{y+1,p}*m_{y+1,p})] (5)

Then, in step 416, the calculation unit 126 may calculate a zero-lapsed mortality rate, R, based on the total population value and the number of expected deaths as of the exercise date, using the following formula:

$$R = \frac{D}{{I}_{P}} \qquad ( 6 )$$

Once the zero-lapsed mortality rate R has been calculated, the processing unit 112 may, in step 418, identify or calculate the premium for the guarantee of insurability for a customer 208 having a starting age y at the exercise date P. Methods for calculating a premium based on a mortality rate will be apparent to persons having skill in the relevant art, such a premium may be based on the zero-lapse mortality rate and also at least one of: interest, persistency, and expenses.

As discussed previously, in an example, an insurability guarantee request may be received by the processing server 102 requesting a premium for a guarantee of insurability of a customer 208 with a starting age of 50 after a deferral period of 5 years. In step 402, the processing unit 112 may identify lapse rates 116 corresponding to the request, as illustrated in Table 1, and may identify base mortality rates 120 and subclass mortality rates 122 corresponding to the request, as illustrated in Table 2. The processing unit 112 may also identify an assumed lapse proportion of 0.7 and identify 1,000 as the predetermined number to use as the original class issue at the start of the deferral period. In the first execution of step 404, the processing unit 112 may increment t to a value of 1 to represent the completion of the first deferral year.

In step 406, the processing unit 112 may identify that the deferral period has not completed, and may proceed to step 408. In step 408, the calculation unit 126 may calculate the first subclass population value, S_{51,1}. As indicated above with respect to equations 1 and 2, for t=1, the calculation unit 126 may calculate only a single subclass population value corresponding to subclass 51. The subclass population value for subclass 51 in the first deferral year may be calculated as 15.4 based on equation 1:

S_{51,1}=O₀*w₁*L=1,000*0.022*0.7=15.4

Then, in step 410, the calculation unit 126 may calculate the total population value as of the end of the first deferral year to be 999.49, based on equation 4:

I₁=I₀−(I₀*M₁)=1,000−(1,000*0.00051)=999.49

Then, in step 412, the calculation unit 126 may calculate the original class issue as of the end of the first deferral year to be 984.09, based on equation 3:

O₁=I₁−(S_{51,1})=999.49−15.4=984.09

The method 400 may then return to step 404, where the processing unit 112 may increment the deferral year to t=2 to represent the end of the second policy year. The method 400 may then proceed from step 406 to step 408, where the calculation unit 126 may calculate subclass population values S_{51,2} and S_{52,2}. As indicated above, S_{51,2} may be calculated using as 15.39, based on equation 2, and S_{52,2} may be calculated as 24.11, based on equation 1:

S_{51,2}=S_{51,1}−(S_{51,1}*m_{51,2})=15.4−(15.4*0.00057)=15.39

S_{52,2}=O₁*w₂*L=984.09*0.035*0.7=24.11

The calculation unit 126 and processing unit 112 may continue to proceed through the method 400, calculating the subclass population values, total population value, and original class value for each deferral year t while t<6, resulting in the values illustrated in Table 3, below:

TABLE 3
Calculated Subclass, Population, and
Original Values—Starting age of 50.

| | Deferral Year (t) | | | | |
|---|---|---|---|---|---|
| | 1 | 2 | 3 | 4 | 5 |
| Iₜ | 999.49 | 998.61 | 997.42 | 996.00 | 994.36 |
| Oₜ | 984.09 | 959.10 | 932.44 | 899.75 | 873.03 |
| S_{51,t} | 15.40 | 15.39 | 15.38 | 15.36 | 15.33 |
| S_{52,t} | | 24.11 | 24.10 | 24.07 | 24.04 |
| S_{53,t} | | | 25.51 | 25.49 | 25.46 |
| S_{54,t} | | | | 31.33 | 31.31 |
| S_{55,t} | | | | | 25.19 |

In step 414, the calculation unit 126 may then calculate the number of expected deaths D as 1.87, using equation 5 based on the data included in Table 2 and Table 3:

D=(O₅*M₅)+[(S_{55,5}*m_{55,5})+(S_{54,5}*m_{54,5})+(S_{53,5}*m_{53,5})+(S_{52,5}*m_{52,5})(S_{51,5}*m_{51,5})]=(873.03*0.00195)+(25.19*0.00087)+(31.31*0.00127)+(25.46*0.00154)+(24.04*0.00170)+(15.33*0.00180)=1.87

In step 416, the calculation unit 126 may then calculate the zero-lapsed mortality rate R as being 0.00188 based on equation 6:

$$R = \frac{D}{{I}_{5}} = \frac{1.87}{994.36} = 0.00188$$

Then processing unit 112 may then calculate or identify (e.g., using a lookup table) a premium for a guarantee of future insurability for a customer 208 starting at age 50 after a deferral period of 5 years using the zero-lapsed mortality rate of 0.00188.

It will be apparent to persons having skill in the relevant art that the values used herein are used for the purposes of illustration only, and that the lapse rates, mortality rates, assumed lapse proportion, and predetermined number may vary from application to application of the zero-lapse adjust method. It will be further apparent to persons having skill in the relevant art that methods and algorithms used to calculate a premium the zero-lapse mortality rate calculated using the method 400 of FIG. 4 may also vary from application to application.

Techniques consistent with the present disclosure provide, among other features, systems and methods for calculating premiums for guarantees of future insurability based on future risk classes. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a premium for a guarantee of future insurability based on a future risk class, comprising:
receiving, by a receiving device, an insurability guarantee request, wherein the insurability guarantee request includes at least a starting age, y, an exercise date at which insurance coverage may be purchased, P, and a particular risk class of a plurality of risk classes;
receiving, by the receiving device, mortality rate data including a plurality of base mortality rates based on an experience, wherein each base mortality rate is associated with the selected risk class, an age, and a policy year and corresponds to a rate of mortality of policy holders of an insurance policy corresponding to the associated risk class, age, and policy year;
receiving, by the receiving device, lapse rate data including a plurality of lapse rates based on the experience or a comparable experience, wherein each lapse rate is associated with the selected risk class, an age, and a policy year, and corresponds to a rate at which policy holders of an insurance policy let their policy lapse as of the end of the associated policy year;
storing, in a mortality database, the received mortality rate data;
storing, in a lapse database, the received lapse rate data;
identifying, by the processing device, an assumed lapse proportion, L, wherein the assumed lapse proportion L represents a proportion of policy holders of an insurance policy that let their policy lapse who experience a lower mortality rate than policy holders of an insurance policy that do not let their policy lapse;
calculating, by the processing device, a plurality of subclass mortality rates, wherein each subclass mortality rate is associated with a selected risk class, an age, a policy year, and a subclass, and corresponds to a rate of mortality of policy holders of an insurance policy corresponding to the associated risk class, age, policy year, and subclass
calculating, by the processing device, a zero-lapsed selected mortality rate, wherein calculating the zero-lapsed selected mortality rate comprises:
calculating, for each deferral year, t, from 1 to P, an original class issue Oₜ, wherein
Oₜ=Iₜ−(S_{y+t,t}−S_{y+t-1,t}− . . . −S_{y+1,t})
Iₜ=Iₜ₋₁−(Iₜ₋₁*mₜ) where Mₜ is a base mortality rate where the associated age is the starting age y and the associated policy year is the deferral year t, and Iₜ represents a total number of survivors at the end of the deferral year t;
S_{i,j}=Oₜ₋₁*wₜ*L when i=(y+t) and S_{i,j}=S_{i,j-1}−(S_{i,j-1}*m_{i,j}) when i<(y+t), where m_{i,j} is a subclass mortality rate where i is the associated subclass, j is the associated policy year, and the associated age is the starting age y, and S_{i,j} represents a number of policy holders who have let their policy lapse during the deferral year t who experience a lower mortality rate than policy holders who did not let their policy lapse during the deferral year t; and
O₀ is a predetermined number,
calculating, for the exercise date, P, the number of expected deaths, D, where D=(Oₚ*M_{y,p})+[(S_{y+p,p}*m_{y+p,p})+(S_{y+p-t,p}*m_{y+p-1,p})+ . . . +(S_{y+1,p}*m_{y+1,p})], and
calculating the zero-lapsed mortality rate, R, where
$$R = \frac{D}{{I}_{P}} ;$$
calculating, by the processing device, a premium based on the calculated zero-lapse mortality rate using a calculation pricing model, wherein the premium corresponds to a guarantee of insurability of an insured at age y at the exercise date P at the selected risk class; and
transmitting, by a transmitting device, the calculated premium in response to the insurability guarantee request.

2. The method of claim 1, further comprising:
calculating, by the processing device, a risk rate, wherein the risk rate is based on at least the calculated zero-lapse mortality rate, interest, persistency, and expenses.

3. The method of claim 2, wherein calculating the premium includes calculating the premium based on a transformation of the calculated risk rate using a calculation pricing model.

4. The method of claim 1, further comprising:
calculating, by the processing device, a reserve using one of: an asset adequacy method, a 1-table method, a 2-table method, and a reserve differential method.

5. The method of claim 1, wherein the calculated premium is one of: a single premium and a periodic premium.

6. The method of claim 5, wherein a period for payment of the periodic premium corresponds to the exercise date P.

7. The method of claim 1, wherein
the insurability guarantee request further comprises at least one additional criteria,
each lapse rate of the plurality of lapse rates is further associated with each of the at least one additional criteria,
each base mortality rate of the plurality of base mortality rates is further associated with each of the at least one additional criteria, and
each subclass mortality rate of the plurality of subclass mortality rates is further associated with each of the at least one additional criteria.

8. The method of claim 7, wherein the at least one additional criteria includes at least one of: gender, medical condition, alcohol usage, tobacco usage, drug usage, medical history, and family medical history.

9. The method of claim 1, wherein each base mortality rate of the plurality of base mortality rates and each subclass mortality rate of the plurality of subclass mortality rates were calculated using a zero-lapse adjusted method.

10. The method of claim 1, wherein each base mortality rate of the plurality of base mortality rates and each subclass mortality rate of the plurality of subclass mortality rates are based on rates published in a valuation basic mortality table.

11. The method of claim 1, wherein the predetermined number is 1,000.

12. A system for identifying a premium for a guarantee of future insurability based on a future risk class, comprising:
a morality database;
a lapse database;
a transmitting device;
a receiving device configured to
receive an insurability guarantee request, wherein the insurability guarantee request includes at least a starting age, y, an exercise date at which insurance coverage may be purchased, P, and a particular risk class of a plurality of risk classes,
mortality rate data including a plurality of base mortality rates based on an experience, wherein each base mortality rate is associated with the selected risk class, an age, and a policy year and corresponds to a rate of mortality of policy holders of an insurance policy corresponding to the associated risk class, age, and policy year, and
lapse rate data including a plurality of lapse rates based on the experience or a comparable experience, wherein each lapse rate is associated with the selected risk class, an age, and a policy year, and corresponds to a rate at which policy holders of an insurance policy let their policy lapse as of the end of the associated policy year; and
a processing device configured to
store, in the mortality database, the received mortality rate data,
store, in the lapse database, the received lapse rate data,
identify an assumed lapse proportion, L, wherein the assumed lapse proportion L represents a proportion of policy holders of an insurance policy that let their policy lapse who experience a lower mortality rate than policy holders of an insurance policy that do not let their policy lapse,
calculate a plurality of subclass mortality rates, wherein each subclass mortality rate is associated with a selected risk class, an age, a policy year, and a subclass, and corresponds to a rate of mortality of policy holders of an insurance policy corresponding to the associated risk class, age, policy year, and subclass,
calculate a zero-lapsed selected mortality rate, wherein calculating the zero-lapsed selected mortality rate comprises:
calculating, for each deferral year, t, from 1 to P, an original class issue Oₜ, wherein
Oₜ=Iₜ−(S_{y+t,t}−S_{y+t-1,t}− . . . −S_{y+1,t})
Iₜ=Iₜ₋₁−(Iₜ₋₁*Mₜ) where Mₜ is a base mortality rate where the associated age is the starting age y and the associated policy year is the deferral year t, and Iₜ represents a total number of survivors at the end of the deferral year t;
S_{i,j}=Oₜ₋₁*wₜ*L when i=(y+t) and S_{i,j}=S_{i,j-1}−(S_{i,j-1}*m_{i,j}) when i<(y+t), where m_{i,j} is a subclass mortality rate where i is the associated subclass, j is the associated policy year, and the associated age is the starting age y, and S_{i,j} represents a number of policy holders who have let their policy lapse during the referral year t who experience a lower mortality rate than policy holders who did not let their policy lapse during the referral year t; and
o₀ is a predetermined number,
calculating, for the exercise date, P, the number of expected deaths, D, where D=(Oₚ*M_{y,p})+[(S_{y+p,p}*m_{y+p,p})+(S_{y+p-1,p}*m_{y+p-1,p})+ . . . +(S_{y+1,p}*m_{y+t,p})], and
calculating the zero-lapsed mortality rate, R, where
$$R = \frac{D}{{I}_{P}} ,$$
and
calculate a premium based on the calculated zero-lapse mortality rate using a calculation pricing model, wherein the premium corresponds to a guarantee of insurability of an insured at age y at the exercise date P at the selected risk class, and
the transmitting device is configured to transmit the calculated premium in response to the insurability guarantee request.

13. The system of claim 12, wherein the processing device is further configured to calculate a risk rate, wherein the risk rate is based on at least the calculated zero-lapse mortality rate, interest, persistency, and expenses

14. The system of claim 13, wherein calculating the premium includes calculating the premium based on a transformation of the calculated risk rate using a calculation pricing model.

15. The system of claim 12, wherein the processing device is further configured to calculate a reserve using one of: an asset adequacy method, a 1-table method, a 2-table method, and a reserve differential method.

16. The system of claim 12, wherein the calculated premium is one of: a single premium and a periodic premium.

17. The system of claim 16, wherein a period for payment of the periodic premium corresponds to the exercise date P.

18. The system of claim 12, wherein the insurability guarantee request further comprises at least one additional criteria,
each lapse rate of the plurality of lapse rates is further associated with each of the at least one additional criteria,
each base mortality rate of the plurality of base mortality rates is further associated with each of the at least one additional criteria, and
each subclass mortality rate of the plurality of subclass mortality rates is further associated with each of the at least one additional criteria.

19. The system of claim 18, wherein the at least one additional criteria includes at least one of: gender, medical condition, alcohol usage, tobacco usage, drug usage, medical history, and family medical history.

20. The system of claim 12, wherein each base mortality rate of the plurality of base mortality rates and each subclass mortality rate of the plurality of subclass mortality rates were calculated using a zero-lapse adjusted method.

21. The system of claim 12, wherein each base mortality rate of the plurality of base mortality rates and each subclass mortality rate of the plurality of subclass mortality rates are based on rates published in a valuation basic mortality table

22. The system of claim 12, wherein the predetermined number is 1,000.

23. A non-transitory computer-readable recording medium having a program stored therein that causes a processor of a mobile device to execute a method for identifying a premium for a guarantee of future insurability based on a future risk class comprising the following steps:
receiving, by a receiving device, an insurability guarantee request, wherein the insurability guarantee request includes at least a starting age, y, an exercise date at which insurance coverage may be purchased, P, and a particular risk class of a plurality of risk classes;
receiving, by the receiving device, mortality rate data including a plurality of base mortality rates based on an experience, wherein each base mortality rate is associated with the selected risk class, an age, and a policy year and corresponds to a rate of mortality of policy holders of an insurance policy corresponding to the associated risk class, age, and policy year;
receiving, by the receiving device, lapse rate data including a plurality of lapse rates based on the experience or a comparable experience, wherein each lapse rate is associated with the selected risk class, an age, and a policy year, and corresponds to a rate at which policy holders of an insurance policy let their policy lapse as of the end of the associated policy year;
storing, in a mortality database, the received mortality rate data;
storing, in a lapse database, the received lapse rate data;
identifying, by the processing device, an assumed lapse proportion, L, wherein the assumed lapse proportion L represents a proportion of policy holders of an insurance policy that let their policy lapse who experience a lower mortality rate than policy holders of an insurance policy that do not let their policy lapse;
calculating, by the processing device, a plurality of subclass mortality rates, wherein each subclass mortality rate is associated with a selected risk class, an age, a policy year, and a subclass, and corresponds to a rate of mortality of policy holders of an insurance policy corresponding to the associated risk class, age, policy year, and subclass
calculating, by the processing device, a zero-lapsed selected mortality rate, wherein calculating the zero-lapsed selected mortality rate comprises:
calculating, for each deferral year, t, from 1 to P, an original class issue Oₜ, wherein
Oₜ=Iₜ−(S_{y+t,t}−S_{y+t-1,t}− . . . −S_{y+1,t});
Iₜ=Iₜ₋₁−(Iₜ₋₁*Mₜ) where Mₜ is a base mortality rate where the associated age is the starting age y and the associated policy year is the deferral year t, and Iₜ represents a total number of survivors at the end of the deferral year t;
S_{i,t}=Oₜ₋₁*wₜ*L when i=(y+t) and S_{i,j}=S_{i,j-1}−(S_{i,j-1}*m_{i,j}) when i<(y+t), where m_{i,j} is a subclass mortality rate where i is the associated subclass, j is the associated policy year, and the associated age is the starting age y, and S_{i,j} represents a number of policy holders who have let their policy lapse during the deferral year t who experience a lower mortality rate than policy holders who did not let their policy lapse during the deferral year t; and
O₀ is a predetermined number,
calculating, for the exercise date, P, the number of expected deaths, D, where D=(Oₚ*M_{y,p})+[(S_{y+p,p}*m_{y+p,p})+(S_{y+p-1,p}*m_{y+p-1,p})+ . . . +(S_{y+1,p}*m_{y+1,p})], and
calculating the zero-lapsed mortality rate, R, where
$$R = \frac{D}{{I}_{P}} ;$$
calculating, by the processing device, a premium based on the calculated zero-lapse mortality rate using a calculation pricing model, wherein the premium corresponds to a guarantee of insurability of an insured at age y at the exercise date P at the selected risk class; and
transmitting, by a transmitting device, the calculated premium in response to the insurability guarantee request.
